(19) United States
(12) Patent Application Publication
(10) Pub. No.: US 2004/0224714 A1
(43) Pub. Date: Nov. 11, 2004

(54) Method for implementing service in radio system user equipment of radio system and radio system

(76) Inventor: Harri Posti, Oulu (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/485,523

(22) PCT Filed: Aug. 2, 2002
(86) PCT No.: PCT/FI02/00653

(30) Foreign Application Priority Data
Aug. 3, 2001 (FI) 20011603

(51) Int. Cl. H04B 7/00; H04Q 7/20

(52) U.S. Cl. 455/522; 455/450; 455/452.1

(57) ABSTRACT

The invention relates to a method for implementing a service in a radio system, user equipment of a radio system and a radio system. The user equipment (170) comprises means (220) for transmitting first data to be transmitted in a first service by using a first logical connection between the user equipment (170) and the radio system, means (220, 222) for establishing the first logical connection by using a first bi-directional physical radio link (208) of the user equipment (170) to a first base transceiver station (162), means (220) for transmitting second data to be transmitted in a second service by using a second logical connection between the user equipment (170) and the radio system, and means (220, 322) for implementing, while the first bi-directional physical radio link (208) is still being used, a second logical connection by using the second bi-directional physical radio link (308) of the user equipment (170) to a second base transceiver station (142).

### FIELD

The invention relates to a method for implementing a service in a radio system, user equipment of a radio system, and a radio system.

### BACKGROUND

Normally, only one service, for instance a call or data transmission, is implemented at a time for each user equipment. When developing new services, the aim is, however, to be able to implement several services simultaneously for one user equipment, for instance the transmission of moving video images and data transmission at the same time. This procedure can be referred to as a multi-call service. In such a case, there are at least two simultaneous logical connections between the network part of the radio system and the user equipment. Each logical connection uses a separate physical channel.

A problem with multi-call services is an efficient use of capacity, since different services set different requirements on the quality and transmission rate of the used physical channel.

### BRIEF DESCRIPTION

The invention seeks to provide an improved method for implementing a service in a radio system, improved user equipment of a radio system and an improved radio system. According to an aspect of the present invention, a method as specified in claim 1 is provided. According to an aspect of the invention, user equipment as specified in claim 11 is provided. According to an aspect of the invention, a radio system as specified in claim 21 is provided. Other preferred embodiments of the invention are disclosed in the dependent claims.

The invention is based on efficiently utilizing the resources of the radio system in such a manner that at least two separate bi-directional physical radio links can be established from the user equipment at the same time to at least two separate base stations, in which case each logical connection can be located on its own physical radio link.

The invention enables an efficient utilization of the resources of the radio system, because each service can be implemented on a physical radio link best suited for it.

### LIST OF FIGURES

Preferred embodiments of the invention are described below by way of example and with reference to the attached drawings, in which

FIG. 1 is a simplified block diagram illustrating the structure of a radio system,

FIG. 2 shows a first embodiment for implementing a service in a radio system,

FIG. 3 shows a second embodiment for implementing a service in a radio system,

FIG. 4 shows a third embodiment for implementing a service in a radio system,

FIG. 5 is a flow chart illustrating a method for implementing a service in a radio system.

### DESCRIPTION OF EMBODIMENTS

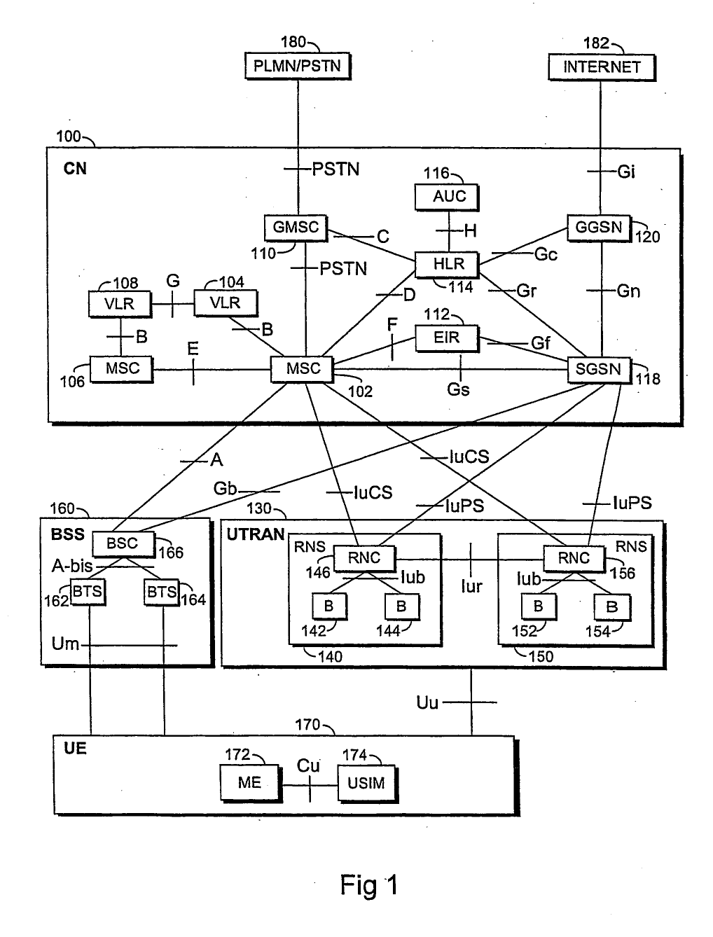

Because second-generation radio systems and third-generation radio systems and various combinations thereof, i.e. so-called 2.5-generation radio systems, are already used worldwide and being continuously developed, the embodiments are described in the radio system illustrated in FIG. 1, which comprises network elements of different generations in parallel. In the description, GSM (Global System for Mobile Communications) represents the second-generation radio systems, a GSM-based radio system, which employs EDGE (Enhanced Data Rates for Global Evolution) technology for increasing the data transmission rate and can also be used for implementing packet transmission in a GPRS (General Packet Radio System) system, represents the 2.5-generation radio systems, and a radio system known at least as IMT-2000 (International Mobile Telecommunications 2000) and UMTS (Universal Mobile Telecommunications System) represents the third-generation radio systems. The embodiments are, however, not restricted to these systems described by way of example, but a person skilled in the art can also apply the instructions to other radio systems containing corresponding characteristics. Further information on the radio system can, if necessary, be obtained in trade literature, for instance in Juha Korhonen: Introduction to 3G Mobile Communications, Artech House 2001, ISBN 1-58053-287-X, which is incorporated herein by reference.

FIG. 1 is a simplified block diagram that shows the most important parts of a radio system and the interfaces between them at network-element level. The structure and functions of the network elements are not described in detail, because they are generally known.

The main parts of a radio system are a core network (CN) 100, a radio access network 130 and user equipment (UE) 170. The term UTRAN is short for UMTS Terrestrial Radio Access Network, i.e. the radio access network 130 belongs to the third generation and is implemented by wide-band code division multiple access (WCDMA) technology. The figure also shows a base station system 160 which belongs to the 2/2.5 generation and is implemented by time division multiple access (TDMA) technology.

On a general level, the radio system can also be defined to comprise user equipment, which is also known as a subscriber terminal and mobile phone, for instance, and a network part, which comprises the fixed infrastructure of the radio system, i.e. the core network, radio access network and base station system.

The structure of the core network 100 corresponds to a combined structure of the GSM and GPRS systems. The GSM network elements are responsible for establishing circuit-switched connections, and the GPRS network elements are responsible for establishing packet-switched connections, some of the network elements are, however, in both systems.

A mobile services switching centre (MSC) 102 is the centre point of the circuit-switched side of the core network 100. The same mobile services switching centre 102 can be used to serve the connections of both the radio access network 130 and the base station system 160. The tasks of the mobile services switching centre 102 include: switching, paging, user equipment location registration, handover management, collection of subscriber billing information, encryption parameter management, frequency allocation management, and echo cancellation.

The number of mobile services switching centres 102 may vary: a small network operator may only have one mobile services switching centre 102, but in large core networks 100, there may be several. FIG. 1 shows a second mobile services switching centre 106, but its connections to other network elements are not shown to keep FIG. 1 sufficiently clear.

Large core networks 100 may have a separate gateway mobile services switching centre (GMSC) 110 that takes care of circuit-switched connections between the core network 100 and external networks 180. The gateway mobile services switching centre 110 is located between the mobile services switching centres 102, 106 and the external networks 180. An external network 180 can be for instance a public land mobile network (PLMN) or a public switched telephone network (PSTN).

A home location register (HLR) 114 contains a permanent subscriber register, i.e. the following information, for instance: an international mobile subscriber identity (IMSI), a mobile subscriber ISDN number (MSISDN), an authentication key, and when the radio system supports GPRS, a packet data protocol (PDP) address.

A visitor location register (VLR) 104 contains roaming information on user equipment 170 in the area of the mobile services switching centre 102. The visitor location register 104 contains almost the same information as the home location register 114, but in the visitor location register 104, the information is kept only temporarily.

An equipment identity register (EIR) 112 contains the international mobile equipment identities (IMEI) of the user equipment 170 used in the radio system, and a so-called white list, and possibly a black list and a grey list.

An authentication centre (AuC) 116 is always physically located in the same place as the home location register 114, and contains a subscriber authentication key Ki and a corresponding IMSI.

The network elements shown in FIG. 1 are functional entities whose physical implementation may vary. Usually, the mobile services switching centre 102 and visitor location register 104 form one physical device, and the home location register 114, equipment identity register 112 and authentication centre 116 form a second physical device.

A serving GPRS support node (SGSN) 118 is the centre point of the packet-switched side of the core network 100. The main task of the serving GPRS support node 118 is to transmit and receive packets with the user equipment 170 supporting packet-switched transmission by using the radio access network 130 or the base station system 160. The serving GPRS support node 118 contains subscriber and location information related to the user equipment 170.

A gateway GPRS support node (GGSN) 120 is the packet-switched side counterpart to the gateway mobile services switching centre 110 of the circuit-switched side with the exception, however, that the gateway GPRS support node 120 must also be capable of routing traffic from the core network 100 to external networks 182, whereas the gateway mobile services switching centre 110 only routes incoming traffic. In our example, external networks 182 are represented by the Internet.

The base station system 160 comprises a base station controller (BSC) 166 and base transceiver stations (BTS) 162, 164. The base station controller 166 controls the base transceiver station 162, 164. In principle, the aim is that the devices implementing the radio path and their functions reside in the base transceiver station 162, 164, and control devices reside in the base station controller 166.

The base station controller 166 takes care of the following tasks, for instance: radio resource management of the base transceiver station 162, 164, intercell handovers, frequency control, i.e. frequency allocation to the base transceiver stations 162, 164, management of frequency hopping sequences, time delay measurement on the uplink, implementation of the operation and maintenance interface, and power control.

The base transceiver station 162, 164 contains at least one transceiver that provides one carrier, i.e. eight time slots, i.e. eight physical channels. Typically one base transceiver station 162, 164 serves one cell, but it is also possible to have a solution in which one base transceiver station 162, 164 serves several sectored cells. The diameter of a cell can vary from a few meters to tens of kilometres. The base transceiver station 162, 164 also comprises a transcoder that converts the speech-coding format used in the radio system to that used in the public switched telephone network and vice versa. In practice, the transcoder is, however, physically located in the mobile services switching centre 102. The tasks of the base transceiver station 162, 164 include: calculation of timing advance (TA), uplink measurements, channel coding, encryption, decryption, and frequency hopping.

The radio access network 130 is made up of radio network subsystems 140, 150. Each radio network subsystem 140, 150 is made up of radio network controllers 146, 156 and B nodes 142, 144, 151, 154. A B node is a rather abstract concept, and often the term base transceiver station is used instead of it.

Operationally, the radio network controller 140, 150 corresponds approximately to the base station controller 166 of the GSM system, and the B node 142, 144, 152, 154 corresponds approximately to the base transceiver station 162, 164 of the GSM system. Solutions also exist in which the same device is both the base transceiver station and the B node, i.e. said device is capable of implementing both the TDMA and WCDMA radio interface simultaneously.

The user equipment 170 comprises two parts: mobile equipment (ME) 172 and UMTS subscriber identity module (USIM) 174. The GSM system naturally uses its own identity module. The user equipment 170 contains at least one transceiver for establishing a radio link to the radio access network 130 or base station system 160. The user equipment 170 can contain at least two different subscriber identity modules. In addition, the user equipment 170 contains an antenna, user interface and battery. Today, there are different types of user equipment 170, for instance equipment installed in cars and portable equipment. Properties better known from personal or portable computers have also been implemented in the user equipment 170. One example of this type of user equipment 170 is Nokia® Communicator®.

USIM 174 contains information related to the user and information related to information security in particular, for instance an encryption algorithm.

Finally, the interfaces between different network elements shown in FIG. 1 are listed in Table 1. In UMTS, the most important interfaces are the lu interface between the core network and the radio access network, which is divided into the interface luCS on the circuit-switched side and the interface luPS on the packet-switched side, and the Uu interface between the radio access network and the user equipment. In GSM, the most important interfaces are the A interface between the base station controller and the mobile services switching centre, the Gb interface between the base station controller and the serving GPRS support node, and the Um interface between the base transceiver station and the user equipment. The interface defines what kind of messages different network elements can use in communicating with each other. The aim is to provide a radio system in which the network elements of different manufacturers interwork so well as to provide an effective radio system. In practice, some of the interfaces are, however, vendor-dependent.

TABLE 1

| | Between network ele- |
|---|---|
| Interface | ments |
| Uu | UE-UTRAN |
| Iu | UTRAN-CN |
| IuCS | UTRAN-MSC |
| IuPS | UTRAN-SGSN |
| Cu | ME-USIM |
| Iur | RNC-RNC |
| Iub | RNC-B |
| A | BSS-MSC |
| Gb | BSC-SGSN |
| A-bis | BSC-BTS |
| Um | BTS-UE |
| B | MSC-VLR |
| E | MSC-MSC |
| D | MSC-HLR |
| F | MSC-EIR |
| Gs | MSC-SGSN |
| PSTN | MSC-GMSC |
| PSTN | GMSC-PLMN/PSTN |
| G | VLR-VLR |
| H | HLR-AUC |
| Gc | HLR-GGSN |
| Gr | HLR-SGSN |
| Gf | EIR-SGSN |
| Gn | SGSN-GGSN |
| Gi | GGSN-INTERNET |

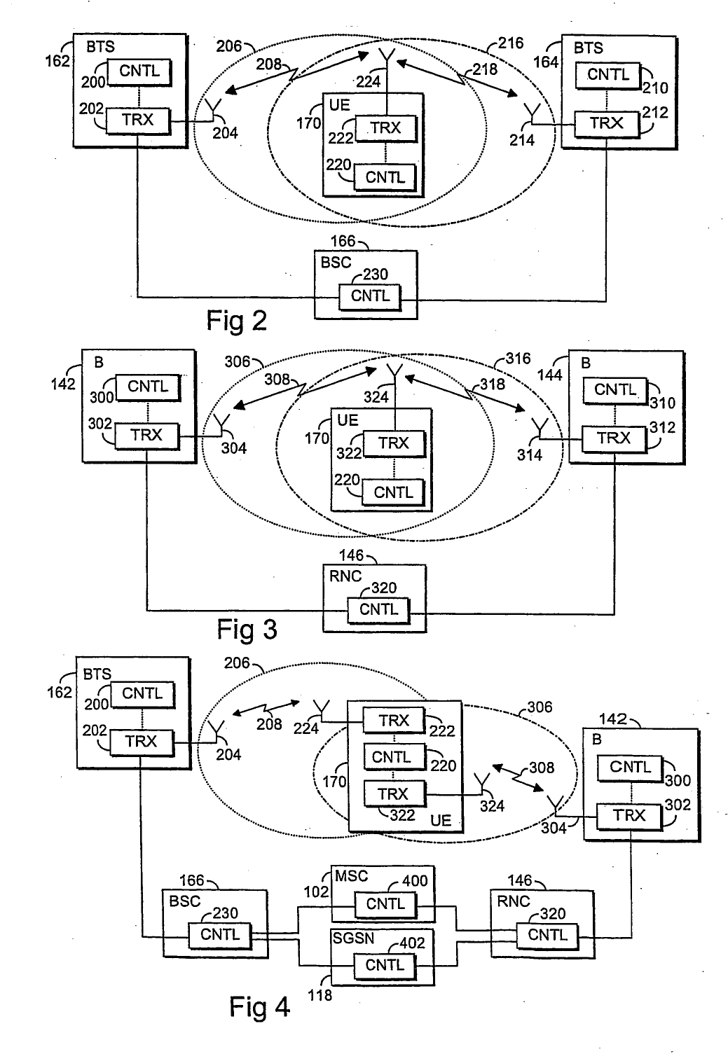

Next, the first embodiment for implementing a service in a radio system is described with reference to FIG. 2. Two base transceiver stations 162, 164 of the base station system 160 have simultaneous radio links 208, 218 with the user equipment 170. The first base transceiver station 162 serves a first cell 206 and the second base transceiver station 164 serves a second cell 216. The base station controller 166 of the base station system 160 controls both base transceiver stations 162, 164.

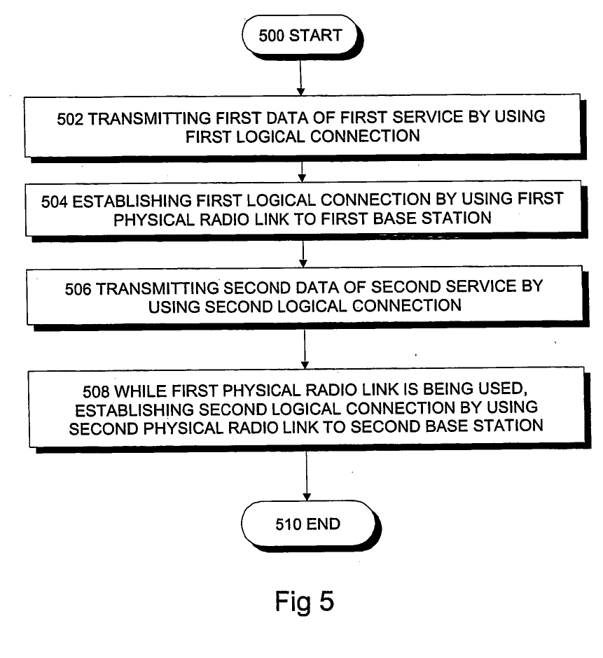

The flow chart of FIG. 5 illustrates, how the method for implementing a service is used in this first embodiment. The execution of the method is started by step 500, in which it is assumed that the user of the user equipment 170 is in contact with the radio system, which in this embodiment is the base transceiver station 162 of the base station system 160. Several services, for instance the transmission of moving video images and data transmission simultaneously, i.e. a multi-call service, are selected for execution simultaneously between the user equipment 170 and radio system. In such a case, at least two simultaneous logical connections are needed between the network part of the radio system and the user equipment. The logical connections can be started and ended at different times.

In step 502, first data to be transmitted in a first service is sent using the first logical connection between the user equipment 170 and the radio system.

In step 504, the first logical connection is established using the first bi-directional physical radio link 208 of the user equipment 170 to the first base transceiver station 162.

In step 506, second data to be transmitted in a second service is sent using the second logical connection between the user equipment 170 and the radio system.

In step 508, while the first bi-directional physical radio link 208 is still in use, the second logical connection is established using the second bi-directional physical radio link 218 of the user equipment 170 to the second base transceiver station 164. As shown in FIG. 2, the user equipment 170 is in an area, in which both the cell 206 of the first base transceiver station 162 and the cell 216 of the second base transceiver station 164 can be heard.

The first base transceiver station 162 comprises a transceiver 202, antenna 204 and control block 200. Similarly, the second base transceiver station 164 comprises a transceiver 212, antenna 214 and control block 210. The base station controller 166 also comprises a control block 230. The user equipment 170 also comprises a normal transceiver 222 and antenna 224 for establishing a radio link, and a control block 220. The transceivers 202, 212, 222 use TDMA technology, and for instance a normal GSM system GMSK (Gaussian Minimum Shift Keying) modulation or EDGE modulation, i.e. 8-PSK (8 Phase Shift Keying) modulation. The antennas 204, 214, 224 can be implemented by normal prior art, for instance as omnidirectional antennas or antennas using a directional antenna beam.

Control blocks 200, 210, 220, 230 refer to blocks controlling the operation of the device, which today are usually implemented using a processor with software, but various hardware implementations are also possible, such as a circuit made of separate logic components or one or more application-specific integrated circuits (ASIC). A combination of these methods is also possible. The functionality described by the actions can thus be implemented by the control blocks 200, 210, 220, 230. In selecting the implementation method, a person skilled in the art will take into consideration for instance the requirements set on the size and power consumption of the device, the required processing power, manufacturing costs and production volumes.

FIG. 2 shows a second embodiment, in which two B nodes 142, 144 belonging to a radio network subsystem 140 are simultaneously in radio contact 308, 318 with user equipment 170. The first B node 142 serves a first cell 306 and the second B node 144 serves a second cell 316. A radio network controller 146 of the radio network subsystem 140 controls both B nodes 142, 144. The method of FIG. 5 for implementing the service is then used in this embodiment, too, i.e. while the first bi-directional physical radio link 308 to the first B node 142 is still being used, a second logical connection is established using the second bi-directional physical radio link 318 of the user equipment 170 to the second B node 144. The second embodiment thus also implements a multi-call service, in which the first data of the first service and the second data of the second service are transmitted between the network part of the radio system and the user equipment 170 by using two separate, but simultaneous radio links 308, 318.

The first B node 142 comprises a transceiver 302, antenna 304 and control block 300. Similarly, the second B node 144 comprises a transceiver 312, antenna 314 and control block 310. The radio network controller 146 also comprises a control block 320. The user equipment 170 also comprises a normal transceiver 322 and antenna 324 for establishing the radio link and a control block 220. The transceivers 302, 312, 320 use the WCDMA technology. The antennas 304, 314, 324 and control blocks 300, 310, 320 can be implemented as described in the first embodiment.

In the first and second embodiments shown in FIGS. 2 and 3, the first physical radio link and the second physical radio link are normally implemented using the same technology, in the first embodiment the TDMA technology and in the second embodiment the WCDMA technology.

However, an embodiment in which the first and second bi-directional physical radio links are implemented using different technologies is also possible. This third embodiment is described next with reference to FIG. 3. In this case, the base transceiver station (‘first base transceiver station’) 162 of the base station system 160 implements the cell 206 and is in radio contact 208 with the first transceiver 222 of the user equipment 170. Simultaneously with the first radio link 208, the second transceiver 322 of the user equipment 170 has a second radio link 308 to the B node (second base transceiver station) 142 of the radio network subsystem 140. The third embodiment thus employs both the first radio link 208 implemented with the TDMA technology and the second radio link 308 implemented with the WCDMA technology to implement the method of FIG. 5 for implementing a multi-call service.

The user equipment 170 can thus also comprise more than one transceiver; in the example, there are two transceivers: both the transceiver 222 employing the TDMA technology and the transceiver 322 employing the ECDMA technology.

FIG. 3 also shows that the operation of both the base station controller 166 and the radio network controller 146 is controlled by a mobile switching centre 102 and serving GPRS support node 118, which both have a control block 400, 402. These control blocks 400, 402 can be implemented as described above. The radio links 208, 218, 308, 318 required to implement the multi-call service in the embodiments shown in FIGS. 2, 3 and 4 can thus be packet-switched and/or circuit-switched.

In one embodiment, the used base transceiver station is selected on the basis of the properties of the base transceiver station 142, 144, 162, 164, because different services have different requirements for the quality and transmission rate of the used physical channel. The used base transceiver station 142, 144, 162, 164 is thus selected on the basis of the properties of the service. This can be implemented in such a manner for instance that speech is transmitted through circuit-switching by using normal GMSK modulation and simultaneously, data is transmitted through packet-switching by using EDGE modulation. A second alternative is that data is transmitted using EDGE modulation and moving audio-video images are transmitted simultaneously using the WCDMA technology. Many different combinations for providing a multi-call service can be implemented applying the presented embodiments. A flexible selection and simultaneous use of several base transceiver stations improves the use of the radio system resources.

The property of the base transceiver station 142, 144, 162, 164 to be taken into account in the selection can be for instance the operational mode of the base transceiver station described above, i.e. the multiple access technology and/or modulation method used in it. The properties of the user equipment 170 affect the selection of the base transceiver station. Other properties to be considered in the selection of the base transceiver station are the physical channel implementing the bi-directional physical radio link and a quality parameter measured from the bi-directional physical radio link. The properties and quality of the channel affect the transmission rate, so they need to be taken into account in selecting the base transceiver station.

In one embodiment, the power control of each bi-directional physical radio link 208, 218, 308, 318 is performed separately, independent of the other bi-directional physical radio links. This further improves the use of the radio system resources, since even though the service is a multi-call service, each physical radio link is treated as an independent entity as regards power control. This includes that a specific quality target controlling the power control, such as a carrier/interference target or signal/noise target, is defined for each bi-directional physical radio link. Similarly, this includes that a specific quality value controlling the power control, such as carrier/interference ratio or signal/noise ratio, is measured for each bi-directional physical radio link.

In one embodiment, handover is performed for each bi-directional physical radio link 208, 218, 308, 318 separately, independent of the other bi-directional physical radio links. In the same way as performing the power control independently for each physical radio link used in one multi-call service, performing handover independently also improves the use of the radio system resources. This includes that inter-cell handover is performed if a channel cannot be found in the serving base transceiver station that fulfils the property requirements set for the channel. This further increases the flexibility of the system and thus improves the use of the resources.

Even though the invention has been explained in the above with reference to examples in accordance with the accompanying drawings, it is apparent that the invention is not restricted to them but can be modified in many ways within the scope of the inventive idea disclosed in the attached claims. The two simultaneous radio links to different base transceiver stations described for the implementation of the multi-call service are only the minimum. There may be more than two simultaneous physical links and more than two base transceiver stations can also be used to implement them.

1. A method for implementing a service in a radio system, comprising:
transmitting first data to be transmitted in a first service by using a first logical connection between user equipment and the radio system,
establishing a first logical connection by using a first bi-directional physical radio link of the user equipment to a first base transceiver station,
transmitting second data to be transmitted in a second service by using a second logical connection between the user equipment and the radio system,
wherein
while the first bi-directional physical radio link 208 is still in use, the second logical connection is established using a second bi-directional physical radio link of the user equipment to a second base transceiver station.

2. A method as claimed in claim 1, wherein the first bi-directional physical radio link and the second bi-directional physical radio link are implemented by different technologies.

3. A method as claimed in claim 1, further comprising selecting the used base transceiver station on the basis of the properties of the base transceiver station.

4. A method as claimed in claim 3, wherein the property of the base transceiver station is at least one of the following: the operational mode of the base transceiver station, the physical channel implementing the bi-directional physical radio link of the base transceiver station, a quality parameter measured from the bi-directional physical radio link.

5. A method as claimed in claim 1, further comprising selecting the used base station on the basis of the properties of the service.

6. A method as claimed in claim 1, further comprising performing a power control of each bi-directional physical radio link separately, independent of the other bi-directional physical radio links.

7. A method as claimed in claim 6, further comprising defining for each bi-directional physical radio link its own quality target controlling the power control, such as a carrier/interference target or signal/noise target.

8. A method as claimed in claim 6, further comprising measuring for each bi-directional physical radio link its own quality value controlling the power control, such as a carrier/interference ratio or signal/noise ratio.

9. A method as claimed in claim 1, further comprising performing handover for each bi-directional physical radio link separately, independent of the other bi-directional physical radio links.

10. A method as claimed in claim 9, further comprising performing an intercell handover, if in the serving base transceiver station, no channel is found that fulfils the properties required of the channel.

11. User equipment of a radio system, comprising:
means for transmitting first data to be transmitted in a first service by using a first logical connection between the user equipment and the radio system,
means for establishing the first logical connection by using a first bi-directional physical radio link of the user equipment to a first base transceiver station,
means for transmitting second data to be transmitted in a second service by using a second logical connection between the user equipment and the radio system,
wherein the user equipment also comprises
means for implementing, while the first bi-directional physical radio link is still being used, a second logical connection by using the second bi-directional physical radio link of the user equipment to a second base transceiver station.

12. User equipment as claimed in claim 11, wherein the first base transceiver station and the second base transceiver station implement the bi-directional physical radio link by using different technologies.

13. User equipment as claimed in claim 11, wherein the user equipment comprises means for selecting the used base transceiver station on the basis of the properties of the base transceiver station.

14. User equipment as claimed in claim 13, wherein the property of the base transceiver station is at least one of the following: the operational mode of the base transceiver station, the physical channel implementing the bi-directional physical radio link of the base transceiver station, a quality parameter measured from the bi-directional physical radio link.

15. User equipment as claimed in claim 11 wherein the user equipment comprises means for selecting the used base station on the basis of the properties of the service.

16. User equipment as claimed in claim 11, wherein the user equipment comprises means for performing the power control of each bi-directional physical radio link separately, independent of the other bi-directional physical radio links.

17. User equipment as claimed in claim 16, wherein the user equipment comprises means for defining for each bi-directional physical radio link its own quality target controlling the power control, such as a carrier/interference target or signal/noise target.

18. User equipment as claimed in claim 16, wherein the user equipment comprises means for measuring for each bi-directional physical radio link its own quality value controlling the power control, such as a carrier/interference ratio or signal/noise ratio.

19. User equipment as claimed in claim 11, wherein the user equipment comprises means for performing handover for each bi-directional physical radio link separately, independent of the other bi-directional physical radio links.

20. User equipment as claimed in claim 19, wherein the user equipment comprises means for performing an intercell handover, if in the serving base transceiver station, no channel is found that fulfils the properties required of the channel.

21. A radio system comprising:
means for transmitting first data to be transmitted in a first service by using a first logical connection between the user equipment and the radio system,
means for establishing the first logical connection by using a first bi-directional physical radio link of the user equipment to a first base transceiver station,
means for transmitting second data to be transmitted in a second service by using a second logical connection between the user equipment and the radio system,
wherein the radio system also comprises
means for implementing, while the first bi-directional physical radio link is still being used, a second logical connection by using the second bi-directional physical radio link of the user equipment to a second base transceiver station.

22. A radio system as claimed in claim 21, wherein the first base transceiver station and the second base transceiver station implement the bi-directional physical radio link by using different technologies.

23. A radio system as claimed in claim 21, wherein the radio system comprises means for selecting the used base transceiver station on the basis of the properties of the base transceiver station.

24. A radio system as claimed in wherein the property of the base transceiver station is at least one of the following: the operational mode of the base transceiver station, the physical channel implementing the bi-directional physical radio link of the base transceiver station, a quality parameter measured from the bi-directional physical radio link.

25. A radio system as claimed in claim 21, wherein the radio system comprises means for selecting the used base station on the basis of the properties of the service.

26. A radio system as claimed in claim 21, wherein the radio system comprises means for performing the power control of each bi-directional physical radio link separately, independent of the other bi-directional physical radio links.

27. A radio system as claimed in claim 26, wherein the radio system comprises means for defining for each bi-directional physical radio link its own quality target controlling the power control, such as a carrier/interference target or signal/noise target.

28. A radio system as claimed in claim 26, wherein the radio system comprises means for measuring for each bi-directional physical radio link its own quality value controlling the power control, such as a carrier/interference ratio or signal/noise ratio.

29. A radio system as claimed in claim 21, wherein the radio system comprises means for performing handover for each bi-directional physical radio link separately independent of the other bi-directional physical radio links.

30. A radio system as claimed in claim 29, wherein the radio system comprises means for performing an intercell handover, if in the serving base transceiver station, no channel is found that fulfils the properties required of the channel.
